(19) United States
(12) Patent Application Publication
(10) Pub. No.: US 2013/0213200 A1
(43) Pub. Date: Aug. 22, 2013

(54) METHOD FOR CUTTING FIBERGLASS INSULATION

(71) Applicant: William Cooper, Johnstown, OH (US)

(72) Inventor: William Cooper, Johnstown, OH (US)

(73) Assignee: OWENS CORNING INTELLECTUAL CAPITAL, LLC, Toledo, OH (US)

(21) Appl. No.: 13/397,791

(22) Filed: Feb. 16, 2012

(51) Int. Cl. B26F 3/00; B05D 7/00; B05D 1/02; B05D 3/12

(52) U.S. Cl. 83/23; 83/53; 83/177

(57) ABSTRACT

Fibrous mineral products, like fiberglass insulation blankets, are cut into lanes or segments using at least one oil-jet cutter that uses high velocity oil to cut a kerf in the blanket. The used or spent oil that is dispersed by the fibers is collected in a separate oil reclamation system that keeps the oil distinct from washwater. The collected oil is filtered, recycled and re-pressurized for additional cutting. Oil is advantageous over water for preserving recovery properties, producing comfortable hand, and reducing the use of de-dusting agents in the process.

### BACKGROUND OF THE INVENTION

The present invention relates generally to the field of manufacture of fibrous pack products such as fiberglass insulation, and, more specifically, to improved methods for cutting or trimming such fibrous products.

Fibrous insulation is typically manufactured by fiberizing a molten composition of polymer, glass or other mineral material to form fine fibers and depositing the fibers on a collecting conveyor to form a batt or a blanket. Mineral fibers, such as glass fibers, are typically used in insulation products. A binder composition may optionally be used to bond the fibers together where they contact each other. During the manufacturing process the insulation products are typically formed and cut to provide sizes generally dimensioned to be compatible with standard construction practices, e.g. standard sized batts or rolls having widths and/or length adapted for specific building cavities or openings. Some insulation products also incorporate a facing material on at least one of the major surfaces. In many cases the facing material is provided as a vapor barrier, while in other insulation products, such as binderless products, the facing material improves the product integrity.

Water-jet cutters have been known. U.S. Pat. No. 6,932,285 to Zeng is representative. Water-jet cutters have sometimes been used to cut large fibrous blankets (e.g. fiberglass insulation) into smaller pieces, either longitudinally or transversely. U.S. Pat. Nos. 3,996,825 and 6,103,049 provide examples of water jet cutting of glass fiber materials. The excess water is typically routed to waste water or recirculated with other washwater for filtering and re-use.

Other types of materials, such as batteries and electronic components have been cut using oil jet cutters. U.S. Pat. No. 6,616,714 is an example of oil jet cutting.

Additionally, it has been known to apply a light mineral oil to fiberglass insulation as a de-dusting agent. U.S. Pat. Nos. 5,683,810, 5,624,742 and 4,555,447 provide examples of dust suppressing agents applied to fiberglass insulation.

### SUMMARY OF THE INVENTION

In one aspect, the invention provides a method for cutting a mineral fiber blanket (fibrous blanket) into sections, the method comprising:

passing the blanket past at least one oil jet cutter, the cutter having a jewel orifice for accelerating highly pressurized oil to supersonic velocity, and a mixing tube for projecting the supersonic velocity oil into the fibrous blanket;

supplying a lightweight oil to the oil jet cutter assembly for acceleration to produce a kerf in the blanket from the supersonic velocity oil; and

collecting oil dispersed by the fibers of the blanket and recycling it back to the supply of lightweight oil.

The lightweight oil supplied may be, for example a vegetable oil or a mineral oil. Lightweight oils generally have a viscosity in the range of less than about 100 cps, more typically less than 80 cps or less than about 60 cps in the useful temperature ranges (e.g. 60 F to 120 F). The method will generally include passing the collected oil through at least one filter to remove particulate matter before returning the oil to the supply. This is because the high velocity breaks the fibers and leaves small fragments of fiber (e.g. glass) in the collected oil. Often a coarse filtration system will be followed with a fine filtration system. Filters may include any type of separation device.

Often the method will involve passing the blanket past an assembly of multiple, spaced apart oil jet cutters, and supplying at least two oil jet cutters of the assembly with oil for acceleration to produce at least two, spaced apart kerfs in the blanket. For example, a cutter assembly may have 6 to 12 cutter jets and they may be selectively operated so that any number of them are in operation, for example two, three, four, five, six, or all of them.

One advantage of the present method is the reduction or elimination of the amount of dedusting oil used for the blanket, the cutting oil applies substitute oil at the kerf, a site of dust particle origination. A second advantage is the elimination of retained water on the product edge that becomes trapped inside the packaging material of the product and can cause product degradation. Another advantage is production of a fibrous blanket with comfortable hand.

The method of the invention is alternatively characterized as follows: In a manufacturing method for forming a mineral fiber blanket and cutting it into lanes using a fluid cutter jet having a jewel orifice for accelerating highly pressurized fluid to supersonic velocity to produce a kerf in the fiber blanket, and then mixing the cutting fluid into the general washwater, the improvement comprises:

using a lightweight oil as the cutter jet fluid; collecting oil dispersed by the fibers of the blanket in a collection pan that separates the oil from the general washwater, and

re-circulating the oil from the collection pan back to the fluid cutter jet.

In a second aspect, the invention provides an apparatus for forming a mineral fiber blanket and cutting it into lanes using a fluid cutter jet having a jewel orifice for accelerating highly pressurized fluid to supersonic velocity to produce a kerf in the fiber blanket, the cutting fluid then mixing with the general washwater, in which the improvement comprises:

a cutter jet adapted to pressurize and accelerate a lightweight oil as the cutting fluid; and

an oil reclamation system for collecting and re-circulating the oil separate from general washwater, the oil reclamation system comprising at least a collection pan disposed beneath the oil jet cutters, a filter, a supply tank, and fluid lines connecting the pan to the filter, and the filter to the supply tank.

As noted above, the apparatus may further comprise at least one coarse filter and at least one fine filter. The apparatus may further comprise at least one pump for moving lightweight oil from the collection pan back to the cutter jets.

One feature of the present invention is to use lightweight oil with a fluid jet cutter to cut a fibrous insulation product into segments, such as lanes or strips. Another feature is the use of special pans or collectors as part of an oil reclamation system to capture oil dispersed by the fibers of the fibrous blanket into a flowing collection pan for recirculation and re-use. The reclamation system also generally comprised a specialized filtration system that removes particulates and cleans the oil for re-use in the cutter jet assemblies.

Another feature of the invention provides an alternative way to add a small amount of oil to a fibrous product as a dust suppressant, particularly near the edges of the product. Yet another feature of the invention provides the product with a comfortable “hand,” or softer feel to the touch.

Other advantages and features are evident from the following detailed description.

### BRIEF DESCRIPTION OF THE DRAWINGS

The accompanying drawings, incorporated herein and forming a part of the specification, illustrate the present invention in its several aspects and, together with the description, serve to explain the principles of the invention. In the drawings, the thickness of the lines, layers, and regions may be exaggerated for clarity.

FIG. 1 is a simplified schematic diagram showing distinct recovery loop systems for a bulk washwater recovery system and a hoodwall washwater recovery system;

FIG. 2 is a partially cross-sectioned view of a typical fluid jet cutter nozzle;

FIG. 3 is a diagrammatic representation of a series of fluid cutters arranged over a fibrous blanket for cutting the blanket into longitudinal strips as it passes beneath; and

FIG. 4 is a viscosity curve for a soybean vegetable oil, plotting viscosity in centistokes against temperature (F).

Various aspects of this invention will become apparent to those skilled in the art from the following detailed description of the preferred embodiment, when read in light of the accompanying drawings.

### DETAILED DESCRIPTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including books, journal articles, published U.S. or foreign patent applications, issued U.S. or foreign patents, and any other references, are each incorporated by reference in their entireties, including all data, tables, figures, and text presented in the cited references.

Unless otherwise indicated, all numbers expressing ranges of magnitudes, such as angular degrees or web speeds, quantities of ingredients, properties such as molecular weight, reaction conditions, dimensions and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements. All numerical ranges are understood to include all possible incremental sub-ranges within the outer boundaries of the range. Thus, a range of 30 to 90 degrees discloses, for example, 35 to 50 degrees, 45 to 85 degrees, and 40 to 80 degrees, etc.

### Forming Fiberglass

The process of manufacturing glass fiber insulation products and non-woven mats has been extensively described in the literature and need not be repeated here. Examples of such disclosure include, but are not limited to U.S. Pat. Nos. 7,754,020, 7,251,959, 7,185,516, and 7,326,304 to Cline, et al; and 8,091,388 to Cooper, et al. each of which is expressly incorporated herein by reference in its entirety. In general, the process involves fiberizing a molten composition of polymer, glass or other mineral material to form fine fibers and depositing the fibers on a collecting conveyor to form a batt or a blanket. Mineral fibers, such as glass fibers, are typically used in insulation products. Coolant water is often sprayed on the molten fibers shortly after formation. Suction may be provided below the conveyor to separate the fibers from the airflow. A binder composition may optionally be used to bond the fibers together where they contact each other. Some binders, such as polyacrylic acid binders and some biobased, carbohydrate binder systems are very acidic. U.S. Pat. Nos. 6,884,849 and 6,699,945 to Chen, et al and 2011/0086567 to Hawkins, et al. Additional water may be used to spray or wash forming equipment.

“Lines,” “fluid lines” and “conduits” are used interchangeably to refer to channels or piping or other means for directing the flow of liquids, such as washwater or oil.

“Makeup water” refers to binder-free water added into the otherwise closed washwater recovery system from an external source that may include pond, river, lake, fresh, well, city or other source of water. Makeup water is generally clean and near neutral pH, that is, having a pH between about 6.5 and about 7.5 although in some cases the pH may be as low as about 6.0 or as high as about 9.5. Also in some cases makeup water may include washwater from other areas or systems.

“Mineral fibers” refers to any mineral material that can be melted to form molten mineral that can be drawn or attenuated into fibers. Glass is the most commonly used mineral material for fibrous insulation purposes and the ensuing description will refer primarily to glass fibers, but other mineral materials useful for insulation include rock, slag and basalt.

### General Washwater Recovery

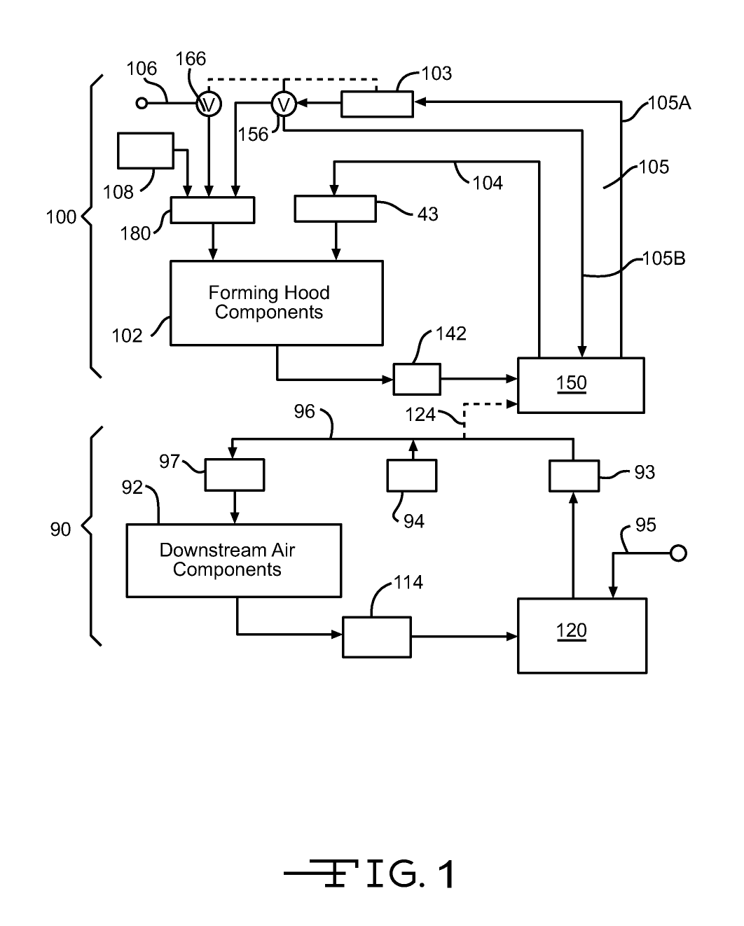

A schematic representation of a fibrous insulation forming line is shown in FIG. 1. As is customary, a washwater recovery system is employed to recirculate washwater used in the forming operation. The system thus comprises a first or “bulk” washwater recovery loop 90 that is used for the “downstream air components” 92 and a second or “hoodwall” washwater recovery loop 100 that is used for the forming hood components 102. It is desirable to segregate these washwater systems since it is preferable to use high pH washwater on the “downstream air components” 92 to reduce the effect of acidic corrosion, yet it is desirable to maintain the acidity of the binder solution for reuse in the forming hood, e.g. for mixing up new batches of binder dispersions. As mentioned, segregation is facilitated by the belt construction of the hoodwalls 40, 48, and by orienting the cleaning system 43 on the outside flight 40B of hoodwall 40.

In the “bulk” washwater recovery loop 90, waste washwater is screened or filtered at 114 to remove glass fibers, collected in bulk washwater supply tank 120. Additional makeup water may be added at 95 to maintain the level in supply tank 120. From supply tank 120, bulk washwater is re-circulated via line 96 back to bulk cleaning system 97 for spraying and washing of downstream air components 92 to complete the recovery loop. Within the loop, pH may be measured at sensor 93 and if the pH is at or below a predetermined target set point, a base such as sodium hydroxide may be added at 94 before the washwater is returned to the bulk cleaning system 97. Maintaining an alkaline bulk washwater minimizes the corrosive effect of any low pH binder that does reach downstream air components 92.

In the “hoodwall” washwater recovery loop 100, waste washwater from the hoodwall is filtered at 142 and collected as filtered hoodwall washwater (FWS) in a binder reclaim tank 150. To replenish the level in the binder reclaim tank 150, water may be added from an alternate source such as makeup water or bulk washwater that may be diverted via cross-system line 124. From binder reclaim tank 150, the FWS may have dual uses upon re-cycling to the forming hood. First, FWS may be used for further hoodwall washing, shown by path 104 leading to a hoodwall cleaning system 43. Second, FWS may be used to prepare new binder dispersion in binder dispersion tank 180, shown by re-circulating loop path 105 with diverter valve 156. The pH of FWS is tested at 103 and the relative amounts of FWS and/or makeup water (from a source via path 106) used in binder dispersion batch preparation are varied using valves 156, 166 according to a predetermined algorithm. As an alternative to measuring the pH of the FWS, one may also measure the pH of existing binder dispersions and adjust the proportions of FWS and makeup water accordingly to yield a desired pH range for preparation of new binder dispersion.

Any overflow from the washwater supply tank 120 is directed by conduit or line 122 back to the sump 110. Any deficit of washwater in the system 90 can be replenished by the addition of water from an external “makeup water” source or by a remote storage tank (not shown) through line 95. With the exception of cross-system lines 124 and 146 (described below), all the washwater from bulk washwater recovery loop 90 is drawn from the washwater supply tank 120 by pumps 126 through conduit or line 128 and directed back to the bulk cleaning system 97 via line 96 and its branches to be reused to clean the downstream air component equipment (e.g. 64, 70, 72, 74, 76). Optionally, the bulk washwater can be pumped through line 130 to a remote storage tank (not shown).

Second, the forming hood components 102 are washed by washwater that is recovered through a separate closed-loop recovery system 100 to keep the hoodwall washwater, which is generally acidic due to a high concentration of low pH binder, from being combined with the bulk washwater in the bulk washwater recovery system 90. Thus, the amount of base solution 94 that would have to be used to raise the pH of the bulk washwater in the washwater supply tank 120 to a pH of approximately 8.0 or more is reduced, saving costs and wasteful neutralization. In order to reduce or eliminate corrosion of the forming hood components 102 from the low pH hoodwall washwater, the walls 40, 48 are preferably constructed of stainless steel or another non-corrosive metal, plastic (e.g., polypropylene or polyethylene), PVC (polyvinyl chloride) piping, or hard polyvinyl chloride (HPVC) piping. Like the forming hood components 102 themselves, the wetted lines and parts of the hoodwall washwater recovery loop 100 should be made of a corrosion resistant material, such as stainless steel, or contain a corrosion resistant coating layer.

The washwater used to clean the forming hood components 102 in the closed-loop recovery system 100 is collected and directed via conduit or line 140 to one or more shaker screen, sieve or filter 142 where larger debris particles are separated from the hoodwall washwater. Alternatively, recovered washwater may be directed to its own sump (not shown) from which it may be pumped back to filter 142 as needed. Filter 142 directs particulates to a scrap chute 116 to be dewatered at 118, as described above with respect to the bulk washwater recovery system 90. Alternatively, filter 142 may directs particulates to a second scrap chute and dewatering press (not shown) whose effluent goes to the binder reclaim tank 120 or, if used, to a sump for the hoodwall washwater system. A plurality of screens, sieves and filters may be represented by 142 for removing all glass fibers and clumped binder from the hoodwall washwater to produce a filtered washwater, or “FWS”.

The FWS passing through the filter 142 is directed into the binder reclaim tank 150. A level sensor 151 monitors the level in binder reclaim tank 150. Any overflow from the binder reclaim tank 150 is directed via line 146 to the bulk washwater supply tank 120 where the hoodwall washwater would be treated with the base solution 94 and converted into bulk washwater. If the level within the binder reclaim tank 150 drops too low, it can be replenished by one of several sources, such as the bulk washwater supply tank 120 via cross-system line 124 or, alternatively, an external makeup water source (not shown). The recovery system 100 is thus “closed loop” except for the makeup source and the two cross system lines 146 and 124 that are only used to maintain appropriate levels in binder reclaim tank 150.

The filtered hoodwall washwater, which has a low pH due to the inclusion of the low pH binder from cleaning the walls 40, 48, may be returned to the forming area 46 for one or both of: (a) delivery to the hoodwall cleaning system 43 for future cleaning of the hoodwalls 40, 48; or (b) reuse in preparing new batches of binder dispersion. In the first case, pump 152 circulates FWS back to the forming hood cleaning system 43 via line 104. Since hoodwall washwater is continuously needed, this re-circulation is ongoing constantly during operation.

In the second case, batches of binder are prepared in binder dispersion tank 180 as needed. Pump 154 continuously re-circulates FWS in a loop via line 105A to a diverter valve 156 and back via line 105B to the binder reclaim tank 150. Diverter valve 156 is capable of diverting FWS via line 158 to the binder dispersion tank 180 whenever a batch of binder is required to be prepared. Diverter valve 156 always allows flow; selecting between outlet line 158 (referred to as “open” to the binder dispersion tank 180) and outlet line 105B back to the binder reclaim tank (referred to herein as “closed” relative to the binder dispersion tank 180).

A pH sensor 103 measures the pH of the FWS within the loop 105A, 105B or in the binder reclaim tank 150 and the pH data signal is processed to control diverter valve 156, and makeup water valve 166 to achieve the desired blend of FWS with makeup water, which blend may be 100% FWS, 100% makeup water or any proportion in between, according to a predetermined algorithm.

### Fluid Jet Cutters

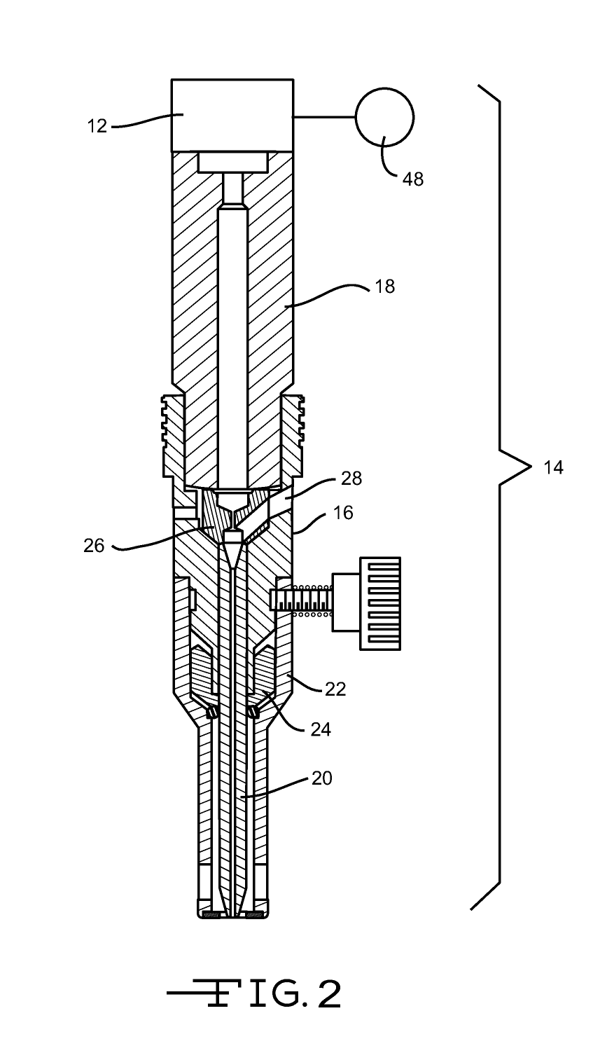

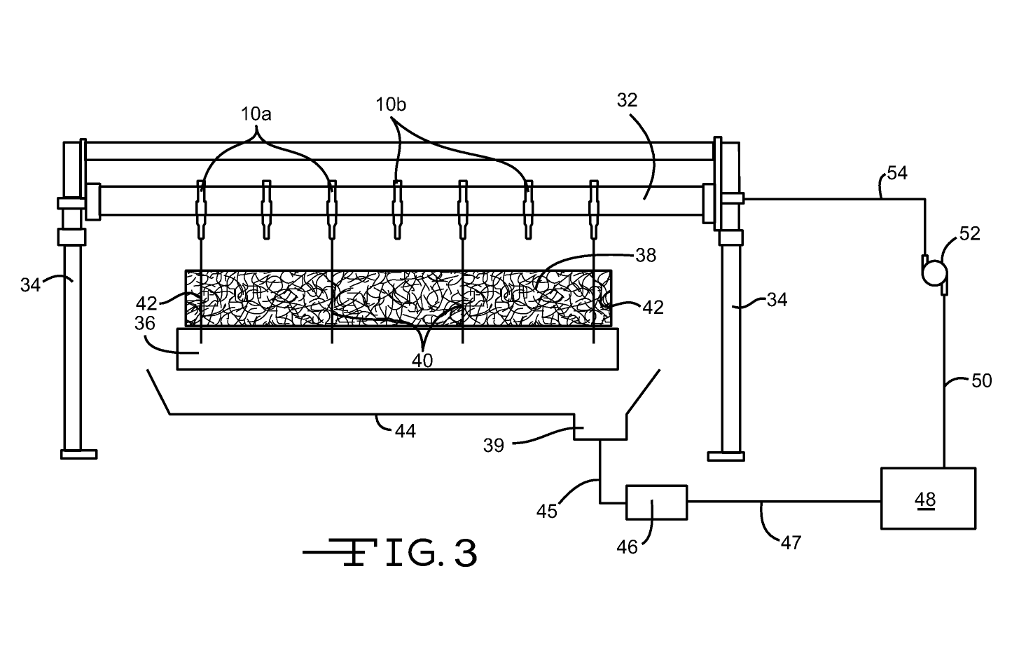

Reference is now made to FIGS. 2 and 3, which show a typical fluid jet cutter nozzle construction and its use on a manufacturing line. Fluid jet cutters are well known and commercially available from a number of suppliers, including at least WARDJet (Tallmadge, Ohio), OMAX (Kent, Wash.), Accustream (New Brighton, Minn.) and International Waterjet Machines (global). U.S. Pat. No. 6,932,285 to Zeng (OMAX) is representative, and incorporated herein by reference. The use of fluid jet cutters is also well documented, and will be described only briefly.

A fluid cutter 10 is composed of two main parts, a pump 12 and a nozzle 14. The purpose of the pump is to create continuous, ultra high pressurization of the fluid, so that its velocity upon exit is very high. Pressures in the range of 30,000 to 60,000 pounds per square inch (“psi”) are commonly used. Depending on exact nozzle configurations, such pressures can produce fluid jet velocities of Mach 1 to Mach 3 (1-3 times the speed of sound). Two types of pumps may be used, an intensifier and a direct drive. Individual pumps 12 may be associated with each nozzle 14, or a single pump 12 may supply a pressurized manifold (not shown) carrying high pressure to each of several cutter nozzles 14.

The nozzle 14 defines whether the jet cutter is a “pure fluid” or “abrasive type.” An abrasive type nozzle is depicted in FIG. 2, and abrasives may be desired for cutting harder materials like metals, stone, composites or ceramics. Abrasives are optional, and generally are not required for cutting fiberglass blankets, even up to 24 inches thick.

The main components of nozzle 14 are a housing 16, into one end of which is threaded an inlet tube 18, and the other end of which contains the mixing tube 20. A guard 22 may surround and protect the mixing tube, but this is optional. The mixing tube 20 and optional guard 22 may be threaded into the housing 16, and retained there by a retaining nut 24.

At the bottom end of the inlet tube is a special part called a “jewel” 26. The jewel 26, defines a fine orifice (“jewel orifice”) that produces the high velocity stream of fluid. It is the fluid velocity, not pressure, that performs the cutting, and the constricting jewel orifice converts the high pressure to extremely high velocity, as is known from the Bernoulli principle. The alignment of the nozzle components is critical. The inlet tube 18, the orifice of the jewel 26, and the mixing tube 20 should all be precisely aligned.

For pure fluid jet cutters, there are no other required parts. However, for abrasive cutting, an abrasive may be added into the jet fluid. Abrasives may include fine particles of sand, garnet or other minerals, which are be available in several mesh sizes. Abrasive is introduced into the housing 16 by a radial inlet tube 28 that intersects the accelerated flow of fluid downstream from the jewel 26 in a “Y” coupling. The abrasive particles are accelerated into the high velocity stream by the Venturi effect. As noted, abrasives are generally not required for cutting fiberglass insulation blankets into lanes or sections.

In conventional fluid jet cutters, the fluid is water. When the high velocity cutting water impacts the mineral fibers (e.g. glass) the water is diffracted or dispersed in multiple directions. This slows the velocity as the energy is transmitted to making the kerf or cut in the fibrous blanket. Water from the cutter jets that is dispersed by the fibers is simply mingled with the general washwater system, which is typically filtered before re-use in order to remove particulates. Water adds unnecessary moisture to the blanket, typically after being dried in the oven. Additionally, small bits of fibers are frequently broken from the blanket to create a “dust” associated with such fibrous products. De-dusting oils may be separately employed to combat this dust.

### Oil Jet Cutting

In the method of the present invention, lightweight oil replaces the water in conventional water jet cutters described above, and oil is used as the fluid. Suitable oils include any lightweight oils such vegetable oils and mineral oil. Oils may be characterized by their properties and composition. Certain physical properties include density or specific gravity, viscosity, surface tension, flashpoint

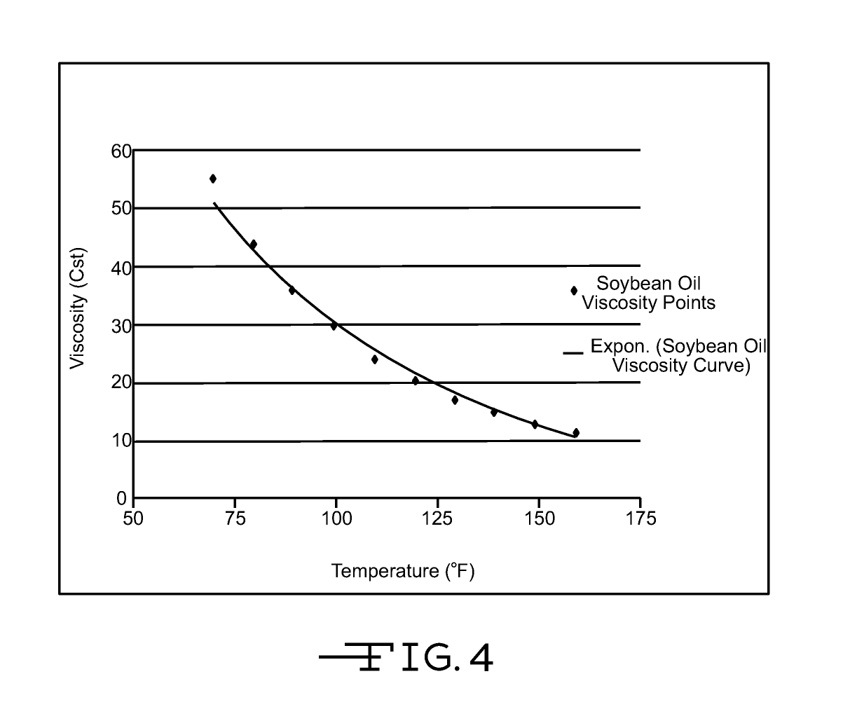

By “lightweight oil” is meant oil that has a suitably low viscosity at the temperatures of use, which may range from about 50 F up to about 120 F, more typically from about 60 F to about 90 F, when used after the blanket emerges from the oven. Viscosity may be measured a number of ways, including absolute viscosity (centipoise—often measured by Brookfield spindle apparatus) or kinematic viscosity (centistokes or Saybolt Units). For oils of interest having a density near 1, the centipoise and centistoke measures are essentially equivalent for a given temperature. Lightweight oils have a viscosity in the useful temperature range of less than about 100 cps, more typically in the range of about 20 to about 80 cps or about 20 to about 60 cps. Generally, oils having suitable viscosity for post-oven cutting will also have suitable viscosity for pre-oven cutting, should that be desired. A viscosity-temperature curve for one suitable soybean oil is provided as FIG. 4. This demonstrates that oil viscosity tends to decrease with increased temperature, so that oils may still be useful if they possess viscosities in the stated ranges over at least a portion of the useful temperature range.

Surface tension is measured in SI units of Newton/meter or, in the cgs system, dyn/cm, which is equivalent to mN/m. Surface tension varies somewhat with temperature, but not to the extent viscosity does. It decreases slightly with higher temperatures. Oils having a surface tension in the range of about 20 to about 50 dyn/cm at 20 C (68 F) are useful, more typically in the range of about 25 to about 35 dyn/cm at 20 C (68 F).

Oils having a flashpoint greater than about 400 F are suitable, although lower flashpoint oils may be equally suitable if cutting occurs after oven drying and curing. For example, oils with flashpoints in the range of 100 F to 400 F may also be used.

Vegetable oils useful in the invention include the oils of many vegetative plants, including for example, babassu, canola, coconut, corn, cottonseed, maize, olive, palm, peanut, pea, rapeseed, soybean, safflower, sunflower, shea, and others. Canola, soy, corn, palm, olive and sunflower are perhaps the more common vegetable oils. Vegetable oils generally comprise a mixture of glycerides, mono- di- and tri-glycerides in varying proportions, the glycerol being esterified to fatty acids of varying length and saturation. Fatty acid esters are generally in the C8 to C18 range for vegetable oils, more commonly in the C12-C18 range. They may be saturated or unsaturated, although unsaturated oils may be preferred in some embodiments. When unsaturated, they may be mono- or poly-unsaturated. Common fatty acid esters found in many vegetable oils include, e.g. laurate, myristate, myristolate, palmitate, palmitolate, stearate, oleate, linolate, and linolenate. The proportion of each fatty acid (and other components of the oils) varies for each vegetable oil (within relatively known ranges) and even with the source of the oils. This is, in part, what makes olive oils from different regions so unique. The density of most vegetable oils is in the range of about 0.8 to about 0.95 g/cm³ at about 2° C. (68 F) “Mineral oils” include any of various colorless, odorless, light mixtures of alkanes in the C15 to C40 range from a non-vegetable source, particularly a distillate of petroleum. Other names for mineral oil include white oil, liquid paraffin, and liquid petroleum. Most often, mineral oil is a liquid by-product of the distillation of petroleum to produce gasoline and other petroleum-based products from crude oil. A mineral oil in this sense is a transparent, colorless oil composed mainly of alkanes and sometimes cyclic paraffins. It is less dense than water, having a density of about 0.8 to about 0.9 g/cm³ at about 20 C (68 F) and a viscosity of about 10-15 centistokes at 40 C (roughly 100 F). The surface tension of mineral oil is about 25 to about 30, more typically about 27 to about 29 dyn/cm at 20 C (68 F).

The viscosities of some representative vegetable oils (given at a relatively high temperature of 100 F) are set forth in Table 1.

TABLE 1
Viscosity ranges of useful vegetable oils at 100 F. (centistokes).

| Oil | Range | Typical |
|---|---|---|
| Olive | 40-55 | 46.7 |
| Cottonseed | 30-45 | 35.8 |
| Rapeseed | 40-60 | 50.6 |
| Soybean | 20-40 | 28.5 |
| Linseed | 20-40 | 29.6 |
| Sunflower | 20-40 | 33.3 |
| Coconut | 20-40 | 29.8 |
| Palm kernel | 20-40 | 30.9 |

For comparison, the surface tension of water at 20 C is about 72.8 dyn/cm and the viscosity is about

These properties and features of lightweight oils produce a number of advantages when used for cutting fiberglass blankets. First, whenever water jets are used to trim fiberglass after drying in the oven, excess moisture can remain in the pack. When fiberglass insulation is packaged with this moisture, it can degrade the physical properties of the insulation over time. One such notable property is the “recovery” of the fiberglass to its nominal height after compression into batts or rolls. Second, for reasons not completely understood, the oils produce a cleaner cut (known as a “kerf”) than does water. Normally a water-produced kerf varies in thickness from top to bottom as the energy of the stream of water dissipates in the fibers over the depth of the cut. With oils, the energy seems to dissipate less quickly, allowing deeper and more uniform cuts for the same amount of input energy. Third, use of oils for cutting can reduce the amount of de-dusting oil added to the insulation elsewhere. Since the cut edges are a primary source of “dust” particles, direct application of oils to the edges by way of cutting with oils, will reduce or eliminate the need for conventional de-dusting oils.

Referring now to FIG. 3, the use of oil jet cutters is illustrated on a manufacturing line 30, as see looking down the line. Several individual cutting jet heads 10 are mounted on a horizontal support 32 in spaced-apart fashion. The spacing may be any interval, but ideally is selected so that the kerfs cut the blanket into “lanes” having widths corresponding to standards widths of insulation batts. For example, 2×4 construction studs on 16 inch centers produces an inter-stud gap of 14.5 inches, and insulation batts are commonly cut to this width to fit into the inter-stud spacing. The cutter heads 10 may be arranged to be stationary on the horizontal support, or they may be arranged to be movable in a transverse direction by a reciprocation mechanism not shown. Transverse adjustment may be desired when different width products are manufactured on the same line. Alternatively, multiple cutter heads may be mounted to accommodate all desired widths, with only apportion of the heads in operation at a given time. For example, cutter heads 10a are shown in operation, while cutter heads 10b are not.

The horizontal support 32 may contain any number of cutter heads 10, for example from 2 to about 12, more often from 3 to about 10, depending on the width of the blanket produced by the forming area. The horizontal support 32 is mounted across two vertical legs 43 that span the manufacturing conveyor 36, which typically has two flights, one down line and the other returning. A fibrous blanket 38 rides on the conveyor 36 down the manufacturing line 10. As the blanket 38 passes beneath the horizontal support 32, the cutters 10 slice the blanket into lanes as represented by kerf lines 40. Similarly, edge trim lines 42 are typically cut from the blanket.

A supply of lightweight cutting oil 48 is circulated by pump 52 through lines 50 and 54 to the horizontal support 32. A manifold (not shown) may be housed inside or attached to the horizontal support to receive the supply of oil and distribute it to each of the cutter heads 10. Pump 52 may be a low pressure pump if individual high pressure pumps are utilized at each cutting nozzle 14. Alternatively, pump 52 may generate the high pressure (e.g, >30,000 psi, or >40,000 psi or >50,000 psi) needed for oil jet cutting and the manifold leading to each cutter nozzle 14 would need to be built to withstand this high pressure.

Below at least the top flight of the conveyor 36 (or, alternatively, below both flights), is a collection pan 44 that collects dispersed, spent oil from the oil jet cutters 10 after it passes through the blanket 38. The mineral fibers disperse the oil into a fine mist that travels laterally as well as downward, so a pan with relatively high collection sides is useful. The pan may be constructed of stainless steel, plastic or other material suitable for collecting lightweight oil. The pan may optionally include a sump 39 or low area to which the oil will drain for collection.

Drain line 45 delivers spent collected oil to filter box 46, which contains a screen or filtration device that removes any particulate matter. It will be understood that the filter box may comprise one or more separation device of any known type, including but not limited to filter screens, filter media, filter membranes, baffles, centrifugal separators, cyclonic separators, and the like. Furthermore, the filter 46 may represent two or more filters in series, such as a coarse filter to remove larger particulates, followed by a fines filter to remove very fine material that may remain in the oil after passing the coarse filter. From filter box 46, line 47 returns oil to the supply 48 for reuse. Additional filters may be inserted in fluid lines at any point in the oil reclamation system. Note that the separate recycling/reclamation system for oil is important since, prior to this invention cutting fluid was simply mingled with other washwater and recycled. However, with cutting oil, this is not desirable. The separate oil reclamation system is composed of at least the pan 44, the supply tank or reservoir 48, a pump 52 and the line connecting them although the sump 39 and filter(s) 46 are likely always included as well.

The foregoing description of the various aspects and embodiments of the present invention has been presented for purposes of illustration and description. It is not intended to be exhaustive or all embodiments or to limit the invention to the specific aspects disclosed. Obvious modifications or variations are possible in light of the above teachings and such modifications and variations may well fall within the scope of the invention as determined by the appended claims when interpreted in accordance with the breadth to which they are fairly, legally and equitably entitled.

What is claimed is:

1. A method for cutting a mineral fiber blanket into sections, the method comprising:
passing the blanket past at least one oil jet cutter, the cutter having a jewel orifice for accelerating highly pressurized oil to supersonic velocity, and a mixing tube for projecting the supersonic velocity oil into the fibrous blanket;
supplying a lightweight oil to the oil jet cutter assembly for acceleration to produce a kerf in the blanket from the supersonic velocity oil; and
collecting oil dispersed by the fibers of the blanket and recycling it back to the supply of lightweight oil.

2. The method of claim 1 wherein the lightweight oil supplied is a vegetable oil.

3. The method of claim 1 wherein the lightweight oil supplied is a mineral oil.

4. The method of claim 1 wherein the lightweight oil is pressurized to a pressure of at least 30,000 psi upon entering the jewel orifice.

5. The method of claim 4 wherein the lightweight oil exits the jewel orifice with a velocity of at least Mach 2.

6. The method of claim 1, further comprising passing the collected oil through at least one filter to remove particulate matter before returning the oil to the supply.

7. The method of claim 1, further comprising collecting the dispersed oil in a pan disposed below the blanket.

8. The method of claim 7, further comprising collecting the dispersed oil in a pan having high sides to collect oil dispersed laterally by the blanket.

9. The method of claim 1, further comprising passing the blanket past an assembly of multiple, spaced apart oil jet cutters, and supplying at least two oil jet cutters of the assembly with oil for acceleration to produce at least two, spaced apart kerfs in the blanket.

10. The method of claim 1 further comprising reducing or eliminating the amount of dedusting oil used for the blanket.

11. The method of claim 1 further comprising producing a fibrous blanket with comfortable hand.

12. In a manufacturing method for forming a mineral fiber blanket and cutting it into lanes using a fluid cutter jet having a jewel orifice for accelerating highly pressurized fluid to supersonic velocity to produce a kerf in the fiber blanket, and then mixing the cutting fluid into the general washwater, the improvement comprising:
using a lightweight oil as the cutter jet fluid;
collecting oil dispersed by the fibers of the blanket in a collection pan that separates the oil from the general washwater, and
re-circulating the oil from the collection pan back to the fluid cutter jet.

13. The method of claim 12 further comprising passing the collected oil through at least one filter to remove particulate matter before returning the oil to the supply.

14. In a manufacturing apparatus for forming a mineral fiber blanket and cutting it into lanes using a fluid cutter jet having a jewel orifice for accelerating highly pressurized fluid to supersonic velocity to produce a kerf in the fiber blanket, the cutting fluid then mixing with the general washwater, the improvement comprising:
a cutter jet adapted to pressurize and accelerate a lightweight oil as the cutting fluid; and
an oil reclamation system for collecting and re-circulating the oil separate from general washwater, the oil reclamation system comprising at least a collection pan disposed beneath the oil jet cutters, a filter, a supply tank, and fluid lines connecting the pan to the filter, and the filter to the supply tank.

15. The apparatus of claim 14, further comprising at least one coarse filter and at least one fine filter.

16. The apparatus of claim 14, further comprising at least one pump for moving lightweight oil from the collection pan back to the cutter jets.

17. The apparatus of claim 14 wherein the lightweight oil is a vegetable oil.

18. The apparatus of claim 14 wherein the lightweight oil is a mineral oil.
